(19) United States
(12) Patent Application Publication
(10) Pub. No.: US 2010/0026885 A1
(43) Pub. Date: Feb. 4, 2010

(54) Image Processing Apparatus

(75) Inventors: Munehiro Terada, Saitama (JP); Kenichi Nagai, Gunma (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/405,059

(22) Filed: Mar. 16, 2009

(30) Foreign Application Priority Data
Aug. 4, 2008 (JP) 2008-201061

(51) Int. Cl. H04N 7/01

(52) U.S. Cl. 348/441

(57) ABSTRACT

According to one embodiment, an image processing apparatus includes a super-resolution converter and a controller. The super-resolution converter performs, on receipt of a video signal with first resolution, super resolution conversion on the video signal to increase the first resolution to second resolution by estimating an original pixel value from the video signal and increasing pixels. The controller controls the super-resolution converter not to perform the super resolution conversion depending on the type of the video signal.

### CROSS-REFERENCE TO RELATED APPLICATIONS

This application is based upon and claims the benefit of priority from Japanese Patent Application No. 2008-201061, filed Aug. 4, 2008, the entire contents of which are incorporated herein by reference.

### BACKGROUND

1. Field

One embodiment of the invention relates to an image processing apparatus.

2. Description of the Related Art

Among recent image processing technologies is a super resolution technology for increasing the resolution of a low-resolution moving video image so that the video image can be clearly displayed on a wide screen. More specifically, the super resolution technology is a technology for increasing the resolution of standard definition (SD) resolution video such as DVD video and analog video by interpolating pixels therein to obtain high definition (HD) resolution video. A determination as to the pixels to be interpolated in the SD resolution video is made based on neighboring pixels (see, for example, Japanese Patent Application Publication (KOKAI) No. 2007-310837.

It has been found that if applied to a digital television, the super resolution technology has poor or adverse effects depending on the type of video. Besides, super resolution processing causes a delay in video output. Therefore, when a user plays, for example, an action game on the digital television, a time lag occurs between video display and user operation, resulting in reduced operation feeling.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of an image processing apparatus according to an embodiment of the invention;

FIG. 2 is an exemplary block diagram of a resolution increasing module in the embodiment;

FIG. 3 is an exemplary table of the relationship between operation modes of the resolution increasing module and image processing performed in each of the operation modes in the embodiment;

FIG. 4 is an exemplary table of types of video images for which the resolution increasing module operates in through mode (hard through mode or soft through mode) and reasons thereof in the embodiment; and

FIG. 5 is an exemplary flowchart of the operation of a resolution increase controller to control the resolution increasing module in the embodiment.

### DETAILED DESCRIPTION

Various embodiments according to the invention will be described hereinafter with reference to the accompanying drawings. In general, according to one embodiment of the invention, an image processing apparatus comprises a super-resolution converter and a controller. The super-resolution converter is configured to perform, on receipt of a video signal with first resolution, super resolution conversion on the video signal to increase the first resolution to second resolution by estimating an original pixel value from the video signal and increasing pixels. The controller is configured to control the super-resolution converter not to perform the super resolution conversion depending on type of the video signal.

According to another embodiment of the invention, an image processing apparatus comprises a super-resolution converter and a controller. The super-resolution converter is configured to perform, on receipt of a video signal with first resolution, super resolution conversion on the video signal to increase the first resolution to second resolution by estimating an original pixel value from the video signal and increasing pixels. The controller is configured to control the super-resolution converter to perform the super resolution conversion at different levels depending on type of the video signal.

According to still another embodiment of the invention, an image processing apparatus comprises a super-resolution converter and a controller. The super-resolution converter is configured to perform super resolution conversion on a video signal with first resolution to increase the first resolution to second resolution. The controller is configured to control the super-resolution converter not to perform the super resolution conversion depending on type of the video signal.

According to still another embodiment of the invention, an image processing method comprises: performing, on receipt of a video signal with first resolution, super resolution conversion on the video signal to increase the first resolution to second resolution by estimating an original pixel value from the video signal and increasing pixels; and controlling the super resolution conversion not to be performed depending on type of the video signal.

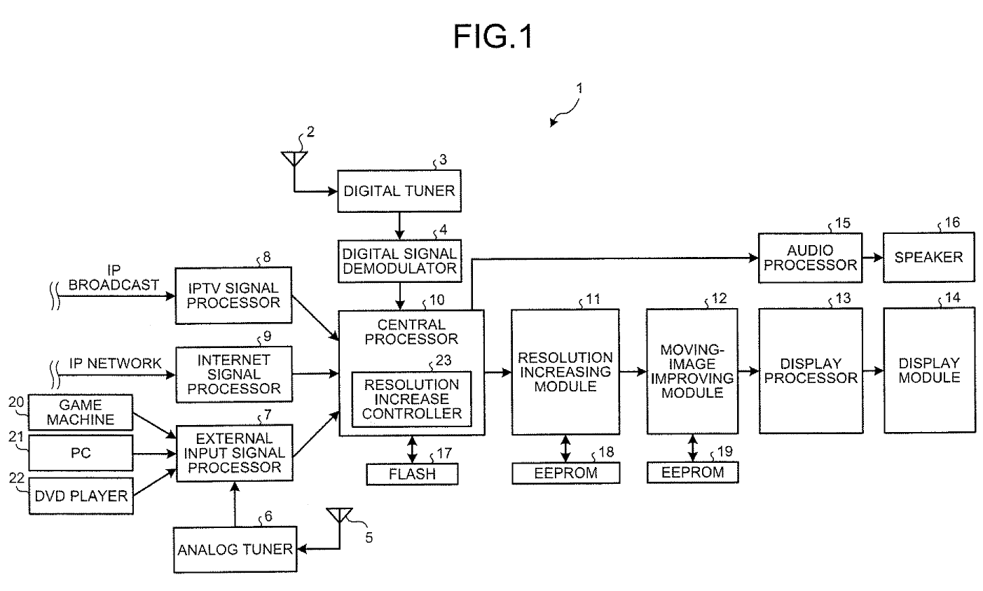

FIG. 1 is a block diagram of an image processing apparatus according to an embodiment of the invention. The image processing apparatus of the embodiment will be described by way of example as being applied to a digital television (TV). As illustrated in FIG. 1, a digital TV 1 comprises a digital antenna 2, a digital tuner 3, a digital signal demodulator 4, an analog antenna 5, an analog tuner 6, an external input signal processor 7, an Internet protocol television (IPTV) signal processor 8, an Internet signal processor 9, a central processor 10, a resolution increasing module 11, a moving-image improving module 12, a display processor 13, a display module 14, an audio processor 15, a speaker 16, a FLASH 17, an electrically erasable programmable read-only memory (EEPROM) 18, and an EEPROM 19.

The digital antenna 2 receives digital broadcasting such as BS broadcasting, CS broadcasting, and digital terrestrial broadcasting. The digital broadcasting includes, in addition to video broadcasting, data broadcasting and electronic program guide (EPG) data. The digital tuner 3 selects a channel to view according to an instruction from a user. The digital signal demodulator 4 demodulates the digital broadcasting to a digital signal.

The analog antenna 5 receives analog broadcasting. The analog tuner 6 selects a channel to view according to an instruction from a user. The external input signal processor 7 performs signal processing on a received analog broadcast signal as well as on a signal received from external devices such as a game machine 20, a personal computer (PC) 21, a digital versatile disk (DVD) player 22.

The IPTV signal processor 8 receives IPTV broadcast signal and performs signal processing thereon. The Internet signal processor 9 receives an internet signal and performs signal processing thereon.

The central processor 10 performs image processing on a received video signal. Examples of the image processing include interlace/progressive (IP) conversion, noise reduction (NR) processing, and scaling. Besides, the central processor 10 comprises a resolution increase controller 23 that controls the resolution increasing module 11 arranged at the latter stage. The resolution increase controller 23 controls operation modes of the resolution increasing module 11 according to the type of a video signal to be sent to the resolution increasing module 11. A detailed description will be given later of how the resolution increase controller 23 controls the resolution increasing module 11.

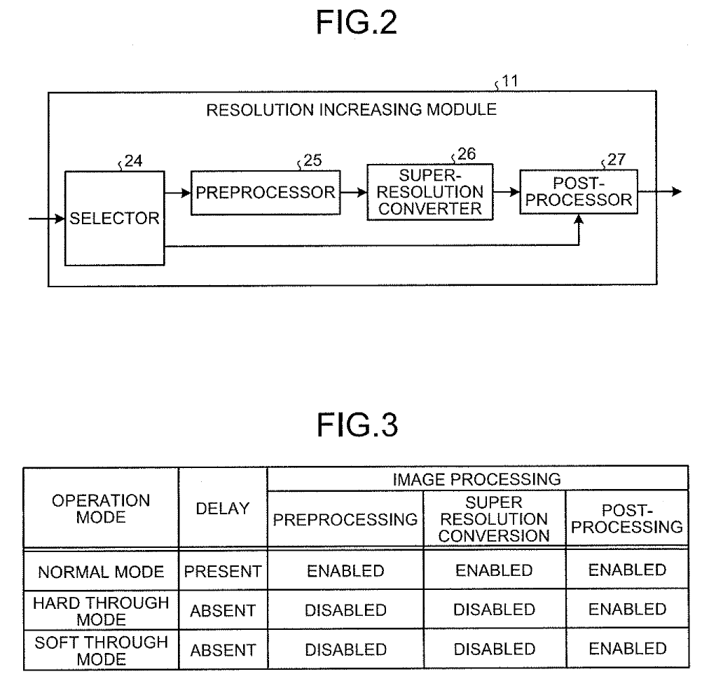

The resolution increasing module 11 increases the resolution of a received video signal (image data). For example, if the video signal represents an SD resolution image, the resolution increasing module 11 converts it to an HD resolution image. FIG. 2 is a block diagram of the resolution increasing module 11. The resolution increasing module 11 comprises a selector 24, a preprocessor 25, a super-resolution converter 26, and a post-processor 27.

The selector 24 is connected to the preprocessor 25 and the post-processor 27, and selects whether to send a received video signal to the preprocessor 25 or to send it directly to the post-processor 27. The preprocessor 25 performs preprocessing on the video signal. More specifically, the preprocessor 25 performs IP conversion and NR processing again on the video signal. The preprocessor 25 may not necessarily be provided according to the specification.

The super-resolution converter 26 performs super resolution conversion on a video signal. The super resolution conversion refers to image sharpening, in which, from an image signal with low resolution, i.e., first resolution, an original pixel value is estimated to increase the pixels and thus to restore an image signal with high resolution, i.e., second resolution. The original pixel value refers to the value of each pixel of an image signal obtained by, for example, photographing the same object as that of an image with the first resolution with a camera having high-resolution pixels and capable of capturing an image with the second resolution. Besides, “original pixel value is estimated to increase the pixels” means to obtain the characteristics of images to find a correlated image, and estimate an original pixel value from neighboring images (in the same frame or between frames) using the correlated image to increase the pixels.

By processing a video signal in this manner, an image having resolution higher than that of the video signal can be created and displayed on the display module 14. The super resolution conversion may be performed using known or commonly used technologies as disclosed in, for example, Japanese Patent Application Publication (KOKAI) Nos. 2007-310837, 2008-98803, and 2000-188680. In the embodiment, the super resolution conversion uses a technology of, for example, restoring an image with frequency components above the Nyquist frequency determined by the sampling rate of an input image.

If employing the super resolution conversion disclosed in Japanese Patent Application Publication (KOKAI) No. 2007-310837, the super-resolution converter 26 sets a target pixel in each of a plurality of low-resolution image signals (image data), and sets a target image area so that it contains the target pixel. The super-resolution converter 26 selects a plurality of correspondent points that correspond to a plurality of target image areas closest to a variation pattern of the pixel value in the target image area from a reference image signal (image data). The super-resolution converter 26 sets a sample value of luminance of a correspondent point to the pixel value of a corresponding target pixel. The super-resolution converter 26 calculates a pixel value for a high-resolution image signal (image data) having more pixels than the reference image signal (image data) and corresponding to the reference image signal (image data) based on the size of a plurality of sample values and layout of the correspondent points. Thus, the super-resolution converter 26 estimates an original pixel value from a low-resolution image signal, and increases the pixels to restore a high-resolution image signal.

If employing the super resolution conversion using self-congruency position search in the same image signal (image data) disclosed in Japanese Patent Application Publication (KOKAI) No. 2008-98803, the super-resolution converter 26 calculates a first pixel position with the smallest error, i.e., a first error, by comparing errors of respective pixels in a search area of a low-resolution image signal. The super-resolution converter 26 calculates a position with the smallest error in the search area with decimal precision based on the first pixel position and the first error, and a second pixel position around a first pixel and a second error thereof. The super-resolution converter 26 calculates a decimal-precision vector that has its end point at the position with the smallest error and its start point at a pixel of interest. The super-resolution converter 26 calculates an extrapolation vector of the decimal-precision vector that has its end point at a pixel on a screen which is not in the search area based on the decimal-precision vector. The super-resolution converter 26 calculates a pixel value for a high-resolution image having more pixels than image data based on a pixel value obtained from the image data, the decimal-precision vector, and the extrapolation vector. In this manner, the super-resolution converter 26 estimates an original pixel value from a low-resolution image signal, and increases the pixels to restore a high-resolution image signal.

The super-resolution converter 26 may employ the super resolution conversion disclosed in Japanese Patent Application Publication (KOKAI) No. 2000-188680 using mapping between a plurality of image signals (image data).

The above technologies of the super resolution conversion are cited by way of example and not by way of limitation. The super-resolution converter 26 may employ various other technologies in which an original pixel value is estimated from a low-resolution image signal to increase the pixels to thereby obtain a high-resolution image signal.

Besides, image sharpening has been known in which the edge of an image is enhanced to sharpen the appearance of the image. The super resolution technology, however, is completely different from the image sharpening in that high-frequency component pixels are newly created.

The post-processor 27 performs post-processing on the video signal. More specifically, the post-processor 27 performs image quality correction such as gamma correction and white balance adjustment on the video signal.

As described above, the resolution increasing module 11 operates in different operation modes according to the type of a received video signal. A description will now be given of the operation modes of the resolution increasing module 11. FIG. 3 illustrates the relationship between the operation modes of the resolution increasing module 11 and image processing performed in each of the operation modes. The operation modes include normal mode and through modes. Further, the through modes includes hard through mode and soft through mode depending on how to skip processing.

In the normal mode, according to a control signal to switch the selector 24 received from the resolution increase controller 23 together with a video signal, the selector 24 sends the video signal to the preprocessor 25. Thus, the video signal is subjected to all the preprocessing by the preprocessor 25, the super resolution conversion by the super-resolution converter 26, and the post-processing by the post-processor 27. For example, on receipt of a video signal except for a full HD (resolution of 1920×1080 pixels) video signal, the resolution increasing module 11 operates in the normal mode. In the normal mode, the super resolution processing causes a delay in video output.

In the through mode, the preprocessing by the preprocessor 25 and the super resolution conversion by the super-resolution converter 26 are skipped so that only the post-processing is performed by the post-processor 27. More specifically, in the hard through mode, according to a control signal to switch the selector 24 received from the resolution increase controller 23 together with a video signal, the selector 24 sends the video signal directly to the post-processor 27. Thus, the video signal is subjected to only the post-processing by the post-processor 27 without undergoing the preprocessing by the preprocessor 25 and the super resolution conversion by the super-resolution converter 26.

In the soft through mode, according to a control signal to switch the selector 24 received from the resolution increase controller 23 together with a video signal, the selector 24 sends the video signal to the preprocessor 25 as in the normal mode. Further, according to the control signal from the resolution increase controller 23, a parameter is set to null for the preprocessing and the super resolution conversion (parameters are set to zero without increasing the sharpening gain). Thus, the preprocessor 25 and the super-resolution converter 26 do not perform their processing, i.e., the preprocessing and the super resolution conversion are disabled, and only the post-processor 27 performs the post-processing. Therefore, in the hard through mode and the soft through mode, delay does not occur due to the super resolution conversion.

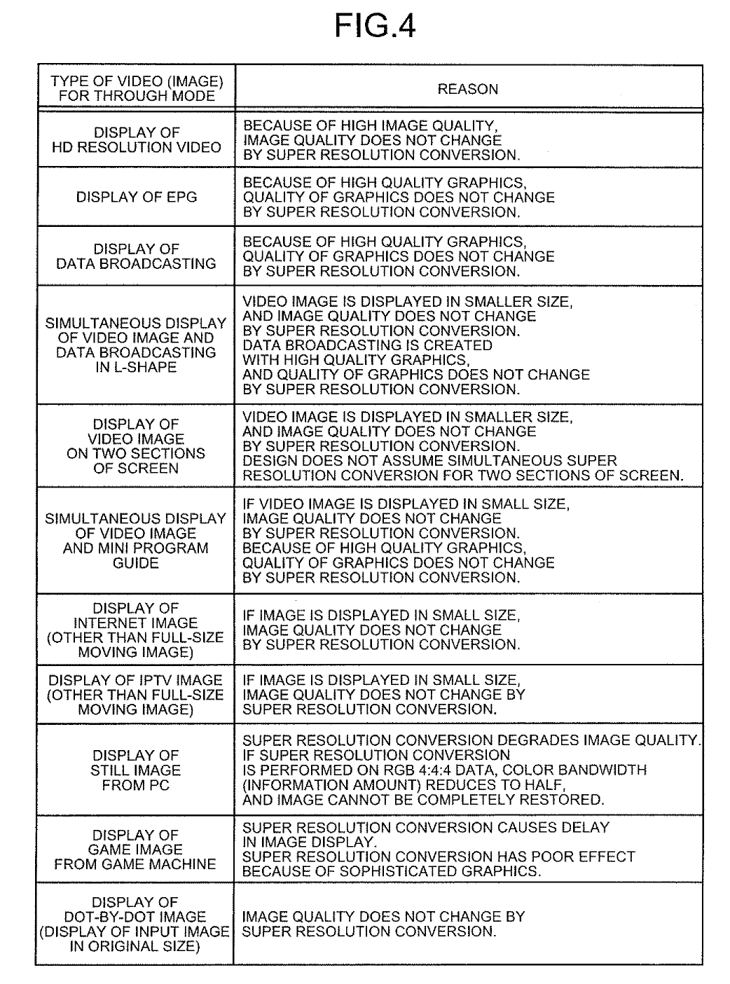

FIG. 4 is a table of types of videos (images) for which the resolution increasing module 11 operates in the through mode (the hard through mode or the soft through mode) and reasons thereof.

In the case of displaying a full HD (resolution of 1920×1080 pixels) video image having high image quality, the image quality does not change even if the super resolution conversion is performed on the video image. Thus, the resolution increasing module 11 operates in the through mode.

In the case of displaying EPG or data broadcasting created with high quality graphics, the quality of the graphics does not change by the super resolution conversion. Thus, the resolution increasing module 11 operates in the through mode.

In the case of displaying a video image with data broadcasting arranged in an L-shape, the video image is displayed in a smaller size. Accordingly, even if the super resolution conversion is performed on the video image, the image quality does not change. Besides, the data broadcasting is created with high quality graphics, and therefore, the quality of the graphics does not change by the super resolution conversion. Thus, the resolution increasing module 11 operates in the through mode.

When a display screen is divided into two sections and a video image is displayed on both the sections, the video image is displayed in a smaller size on both of them. Accordingly, even if the super resolution conversion is performed on the video image, the image quality does not change. Besides, the design does not assume simultaneous super resolution conversion for such two sections of the screen. Thus, the resolution increasing module 11 operates in the through mode.

In the case of displaying a video image with a mini program guide, if the video image is displayed in a small size, the image quality does not change by the super resolution conversion. Besides, because of the high quality graphics, the quality of the graphics does not change by the super resolution conversion. Thus, the resolution increasing module 11 operates in the through mode. If the video image is displayed in a large size, the operation mode can be switched so that the resolution increasing module 11 can operate in the normal mode.

In the case of displaying an IPTV image or an Internet image other than full-size moving images, if the image is displayed in a small size, the image quality does not change by the super resolution conversion. Thus, the resolution increasing module 11 operates in the through mode.

In the case of displaying a still image from a PC such as an image of video graphics array (VGA) resolution or extended graphics array (XGA) resolution, the super resolution conversion has an adverse effect on the image and the image quality degrades. This is because, if the super resolution conversion is performed on RGB4:4:4 data, the chroma (color) bandwidth, i.e., information amount, reduces to half. Consequently, the image cannot be completely restored. Therefore, the resolution increasing module 11 operates in the through mode.

In the case of displaying a game image from a game machine, the super resolution conversion causes a delay in image display. In addition, the super resolution conversion has a poor effect on the game image since its graphics are sophisticated. Thus, the resolution increasing module 11 operates in the through mode.

In the case of dot-by-dot display in which an input image is displayed in its original size, even if the super resolution conversion is performed on the image, the image quality does not change. Thus, the resolution increasing module 11 operates in the through mode.

Whether the resolution increasing module 11 operates in the hard through mode or the soft through mode depends on the type of the video (image). Generally, the resolution increasing module 11 operates in the hard through mode for display of a still image from a PC, a game image, and a dot-by-dot image. For other videos (images), a determination is made at design time as to which of the hard through mode or the soft through mode is applied.

The moving-image improving module 12 performs moving-image improvement on a received video image. More specifically, the moving-image improving module 12 converts the frame rate of a video signal transmitted at 60 frames per second (fps) to 120 fps by high-quality motion interpolation. This reduces image blur in a portion in which an object moves horizontally, vertically, and diagonally or rotates as well as efficiently suppressing noise. Thus, a telop sequence, a sports scene with fast motion, etc. can be displayed clearly on the display module 14.

The display processor 13 superimposes a graphic such as text data on a video image having undergone adjustment. The display module 14 displays the video image on the screen. Incidentally, specific graphics such as data broadcasting are superimposed on a video image in two different manners. That is, such graphics are superimposed on a video image by the display processor 13 or the central processor 10. The user views television images displayed on the screen of the display module 14. The audio processor 15 performs audio processing on an audio signal as well as amplifying the audio signal. The speaker 16 outputs the audio signal as sound. The user listens to the sound from the speaker 16 as television sound.

The FLASH 17 is a flash memory that stores data necessary for the central processor 10. The EEPROM 18 can be electrically overwritten or rewritten, and stores data necessary for the resolution increasing module 11. The EEPROM 19 can also be electrically overwritten or rewritten, and stores data necessary for the moving-image improving module 12.

The hard through mode and the soft through mode described above are applied to the case where the central processor 10 superimposes a graphic such as data broadcasting on a video image. Meanwhile, in the case where the display processor 13 superimposes a graphic such as data broadcasting on a video image, the through mode may be applied partially in the following manner.

For example, when a video image is displayed simultaneously with data broadcasting arranged in an L-shape, the resolution increase controller 23 specifies a position of the video image where the graphic of the data broadcasting is to be superimposed based on a graphic signal. According to an instruction from the resolution increase controller 23, the resolution increasing module 11 performs the super resolution conversion on the video image except for the position where the graphic is to be superimposed. Thereafter, the display processor 13 superimposes the graphic on the video image subjected to the super resolution conversion. Besides, in the case of dot-by-dot display, the position of an input image may be specified based on coordinate information so that the super resolution conversion is not to be performed on the coordinate area.

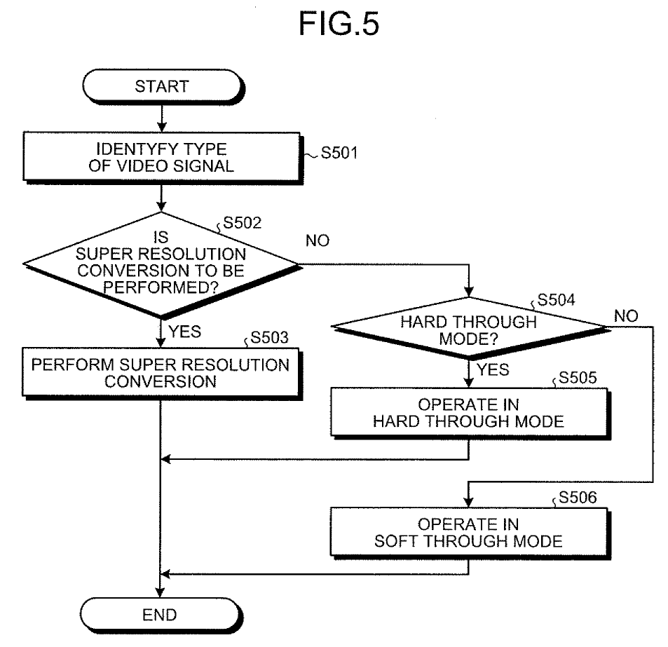

Described below is how the resolution increase controller 23 controls the resolution increasing module 11. FIG. 5 is a flowchart of the operation of the resolution increase controller 23 to control the resolution increasing module 11. First, the resolution increase controller 23 identifies the type of a video signal to be sent to the resolution increasing module 11 at the latter stage based on information (information from user operation or other modules) obtained by the central processor (S501).

The resolution increase controller 23 then determines whether to perform the super resolution conversion on the video signal (S502). This determination is made according to the type of the video signal as described previously in connection with FIG. 4. Upon determining to perform the super resolution conversion on the video signal (Yes at S502), the resolution increase controller 23 instructs the resolution increasing module 11 to perform the super resolution conversion (S503). More specifically, the resolution increase controller 23 sends a control signal for this instruction to the resolution increasing module 11 together with the video signal. According to the control signal, the resolution increasing module 11 switches the selector 24 to output the video signal to the preprocessor 25, and operates in the normal mode.

Upon determining not to perform the super resolution conversion on the video signal (No at S502), the resolution increase controller 23 determines whether the hard through mode is applied to the video signal (S504). Upon determining to apply the hard through mode to the video signal (Yes at S504), the resolution increase controller 23 controls the resolution increasing module 11 to operate in the hard through mode (S505). More specifically, the resolution increase controller 23 sends a control signal for this instruction to the resolution increasing module 11 together with the video signal. According to the control signal, the resolution increasing module 11 switches the selector 24 to output the video signal to the post-processor 27, and operates in the hard through mode.

On the other hand, upon determining to apply not the hard through mode but the soft through mode to the video signal (No at S504), the resolution increase controller 23 controls the resolution increasing module 11 to operate in the soft through mode (S506). More specifically, the resolution increase controller 23 sends a control signal for this instruction to the resolution increasing module 11 together with the video signal. According to the control signal, the resolution increasing module 11 switches the selector 24 to output the video signal to the preprocessor 25, and sets a parameter to null for the preprocessor 25 and the super-resolution converter 26, thereby operating in the soft through mode. In this manner, the resolution increase controller 23 controls the resolution increasing module 11.

Although described above as having two through modes, i.e., the hard through mode and the soft through mode, the image processing apparatus of the embodiment may have either one of the through modes (particularly, the hard through mode).

Besides, in the soft through mode described above, a parameter is set to null for the super resolution conversion (the parameter is set to zero without increasing the sharpening gain) so that the super-resolution converter 26 does not perform the super resolution conversion. Alternatively, in addition to the soft through mode, a mode (low super-resolution processing mode) may be set in which a parameter is set to a value lower than in the normal mode for the super resolution conversion (the parameter is set to increase the sharpening gain a little). In the low super-resolution processing mode, the super-resolution converter 26 performs on a video signal the super resolution conversion at a level lower than in the normal mode.

As set forth hereinabove, according to an embodiment, the image processing apparatus does not perform super resolution conversion on a video signal on which the super resolution conversion has a poor effect. In this manner, by skipping the super resolution conversion, it is possible to reduce the load on the image processing apparatus.

Besides, the image processing apparatus does not perform super resolution conversion on a video signal when the super resolution conversion degrades the image quality of the video signal. Thus, it is possible to prevent the degradation of image quality due to the super resolution conversion.

Furthermore, the image processing apparatus does not perform super resolution conversion on a video signal when the super resolution conversion has an adverse effect on the video signal (e.g., delay in video output). Therefore, an adverse effect from the super resolution conversion can be prevented.

In addition, the image processing apparatus may perform super resolution conversion on a video signal, on which the super resolution conversion has a poor effect, at a level lower than in normal mode. With this, it is possible to reduce the load on the image processing apparatus, noise enhancement, and the like.

The information processing apparatus of the above embodiment is described by way of example as being applied to the digital TV 1 comprising the display processor 13, the display module 14, the audio processor 15 and the speaker 16; however, it can be applied to, for example, a tuner or a set-top box without having those modules.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image processing apparatus comprising:
a super-resolution converter configured to perform, on receipt of a video signal with first resolution, super resolution conversion on the video signal to increase the first resolution to second resolution by estimating an original pixel value from the video signal and increasing pixels; and
a controller configured to control the super-resolution converter not to perform the super resolution conversion depending on type of the video signal.

2. The image processing apparatus of claim 1, wherein the controller is configured to control the video signal not to input to the super-resolution converter depending on the type of the video signal.

3. The image processing apparatus of claim 2, further comprising a selector configured to select whether to send the video signal to the super-resolution converter, wherein
the controller is configured to control the selector not to send the video signal to the super-resolution converter depending on the type of the video signal.

4. The image processing apparatus of claim 1, wherein the controller is configured to control the super-resolution converter to disable the super resolution conversion.

5. The image processing apparatus of claim 1, wherein the controller is configured to control the super-resolution converter not to perform the super resolution conversion when the video signal represents a still image.

6. The image processing apparatus of claim 1, wherein the controller is configured to control the super-resolution converter not to perform the super resolution conversion when the video signal represents a game image.

7. The image processing apparatus of claim 1, wherein the super-resolution converter is configured to perform the super resolution conversion on part of the video signal.

8. The image processing apparatus of claim 1, further comprising a display module configure to display the video signal.

9. An image processing apparatus comprising:
a super-resolution converter configured to perform, on receipt of a video signal with first resolution, super resolution conversion on the video signal to increase the first resolution to second resolution by estimating an original pixel value from the video signal and increasing pixels; and
a controller configured to control the super-resolution converter to perform the super resolution conversion at different levels depending on type of the video signal.

10. An image processing apparatus comprising:
a super-resolution converter configured to perform super resolution conversion on a video signal with first resolution to increase the first resolution to second resolution; and
a controller configured to control the super-resolution converter not to perform the super resolution conversion depending on type of the video signal.
